(19) United States
(12) Patent Application Publication
(10) Pub. No.: US 2016/0306885 A1
(43) Pub. Date: Oct. 20, 2016

(54) METHOD AND APPARATUS FOR DETERMINING CORE WORD OF IMAGE CLUSTER DESCRIPTION TEXT

(71) Applicant: BEIJING QIHOO TECHNOLOGY COMPANY LIMITED, Beijing (CN)

(72) Inventor: Zhe TAO, Beijing (CN)

(21) Appl. No.: 15/103,267

(22) PCT Filed: Sep. 22, 2014
(86) PCT No.: PCT/CN2014/087084

§ 371 Date: Jun. 9, 2016

(30) Foreign Application Priority Data
Dec. 11, 2013 (CN) 201310674702.3

(51) Int. Cl. G06F 17/30

(52) U.S. Cl. CPC G06F 17/30864; G06F 17/30253

(57) ABSTRACT

The disclosure discloses a method and an apparatus for determining a core word of an image cluster description text. The method comprises segmenting the each image description text in the text cluster, and based on attribute information of each base word, determining a fractional value of the each base word in the each image description text and a total fractional value of the each base word in the text cluster, and thus determining a core word of the image cluster. Embodiments of the present disclosure may determine a weight of each base word in the each image description text, determine a total fractional value of the each base word in the text cluster, based on the total fractional value of the each base word, determine a core word of the image cluster, and thus can ensure that the selected core word can accurately describe a meaning of the image cluster.

### CROSS-REFERENCE TO RELATED APPLICATIONS

This application is the national stage of International Application No. PCT/CN2014/087084 filed Sep. 22, 2014, which is based upon and claims priority to Chinese Patent Application No. CN201310674702.3, filed Dec. 11, 2013, the entire contents of which are incorporated herein by reference.

### FIELD OF TECHNOLOGY

The disclosure relates to the field of data communication technology and, more particularly, to a method and apparatus of determining core word of image cluster description text.

### BACKGROUND

In the conventional technology, search engines craw pages in the Internet via web crawler or web spider. The core word of each page may be determined aiming at the description text of each page.

However, when the search engine performs a similarity identification to massive images, it may find groups of similar images. Each image has an image description text which is not totally the same as that in the original webpage, and the image description text may also be fake description. Therefore, it is very hard to determine the true image description text or the core word of the content of the image. To the massive images which are uploaded fast, it is not possible to label by human. In addition, because the number of byte included in the image description text is less, and there may also be interference information which is irrelative to the image, the accurate core word cannot be determined, and it makes great difficulty for determining the core word or the description text accurately matching the image.

### SUMMARY

In the view of above problems, the disclosure is proposed to provide a method and apparatus for determining a core word of an image cluster description text in order to overcome the problem or at least solve part of the problems above.

An embodiment of the present disclosure discloses a method for determining a core word of an image cluster description text, comprising: aiming at each image cluster, extracting an image description text of each image in the image cluster, and storing each image description text in a text cluster; segmenting each image description text in the text cluster to obtain a base word of each image description text; according to attribute information of the base word, determining a weight of each base word in each image description text, and determining a fractional value of each base word in each image description text; according to the fractional value of each base word in each image description text, determining a total fractional value of each base word in the text cluster; according to the total fractional value of each base word in the text cluster, determining the core word of the image cluster.

An embodiment of the present disclosure discloses an apparatus for determining a core word of an image cluster description text, comprising: an image cluster library, configured to store each image cluster, wherein each image cluster comprises a plurality of images, and determine the core word of each image cluster according to a core word extracting module, store a relation between each image cluster and the core word; a text cluster library configured to store a text cluster constituted by the image description texts extracted from each image in the image cluster aiming at each image cluster; a word segmenting module, configured to segment each image description text in the text cluster and obtain a base word in each image description text; a fractional value calculation module configured to determine a weight of each base word in each image description text according to the attribute information of each base word, and determine the fractional value of each base word in each image description text; a total fractional value calculation module, configured to determine the total fractional value of each base word in the text cluster according to the fractional value of each base word in each image description text; a core word extracting module, configured to determine the core word of the image cluster according to the determined total fractional value of each base word in the text cluster.

The disclosure discloses a method and an apparatus for determining a core word of an image cluster description text, The method aiming at a text cluster comprising each image description text in an image cluster, segmenting the each image description text in the text cluster, and based on attribute information of each base word, determining a fractional value of the each base word in the each image description text and a total fractional value of the each base word in the text cluster, and thus determining a core word of the image cluster. Embodiments of the present application aim at a text cluster comprising each image description text in an image cluster, based on attribute information of a base word in the each image description text, determine a weight of each base word in the each image description text, determine a total fractional value of the each base word in the text cluster, based on the total fractional value of the each base word, determine a core word of the image cluster, and thus can ensure that the selected core word can accurately describe a meaning of the image cluster.

Described above is merely an overview of the inventive scheme. In order to more apparently understand the technical means of the disclosure to implement in accordance with the contents of specification, and to more readily understand above and other objectives, features and advantages of the disclosure, specific embodiments of the disclosure are provided hereinafter.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the invention. Further, throughout the drawings, same elements are indicated by same reference numbers. In the drawings:

FIG. 1 is a schematic diagram showing the process of determining a core word of an image cluster description text according to an embodiment of the present disclosure;

FIG. 2 is a schematic diagram showing the detailed implementing process of determining a core word of an image cluster description text according to an embodiment of the present disclosure;

FIG. 3 is another schematic diagram showing the detailed implementing process of determining a core word of an image cluster description text according to an embodiment of the present disclosure;

FIG. 4 is still another schematic diagram showing the detailed implementing process of determining a core word of an image cluster description text according to an embodiment of the present disclosure;

FIG. 5 is a schematic diagram showing the structure of the apparatus for determining a core word of an image cluster description text according to an embodiment of the present disclosure;

FIG. 6 is a block diagram showing a computing apparatus which is configured to execute the method according to the invention; and

FIG. 7 schematically shows the storage unit which is configured to hold or carry the program codes according to the method of the present disclosure.

### DESCRIPTION OF THE EMBODIMENTS

In order to accurately determine a core word of the image cluster of a plurality of similar images and describe the meaning of the image cluster, an embodiment of the present disclosure discloses a method and apparatus for determining a core word of the image cluster description text.

When performing the core word in an embodiment of the present disclosure, the whole process is abstracted to be a voting process. For example, there are ten voters, N candidates, each voter has the right of voting once. In the embodiment of the present disclosure, the once voting right of each voter is divided, such as voting to A for 0.1 votes, and voting to B for 0.9 votes.

Each voter has its background and dominant ideology, which makes the voting result different. In many time's voting, there is a rank between candidates after each time's voting. The voters may be enlightened by the current voting result and adjust their next voting. In addition, the voting result may present some “bad voters”, these voters should be removed from the voters, and the candidates they voted may be bad suspicious candidates.

In the embodiment of the present disclosure, based on the abstract process, the base word may be considered as a voter, the image description text may be considered as a candidate, the image description text may be determined according to the attribute information of the base word, thusly the core word is determined.

Hereinafter, the embodiment of the present disclosure may be illustrated accompanying with figures.

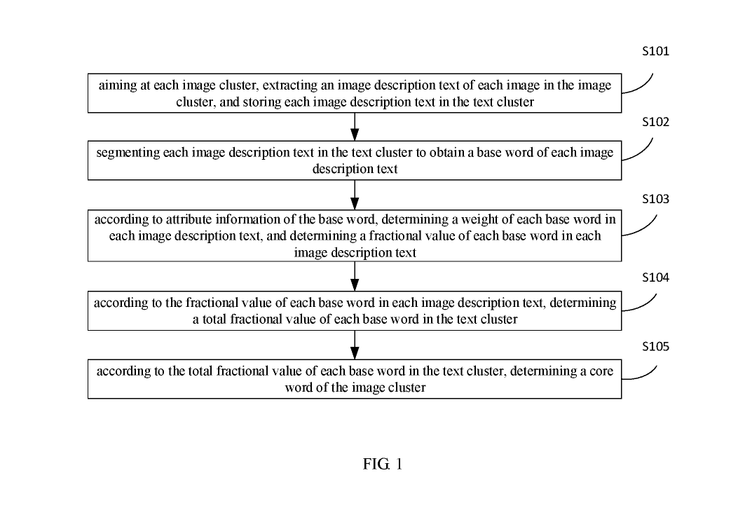

FIG. 1 is a schematic diagram showing the process of determining a core word of an image cluster description text according to an embodiment of the present disclosure; the process may include the following steps:

S101, aiming at each image cluster, extracting an image description text of each image in the image cluster, and storing each image description text in the text cluster.

Each image cluster includes a plurality of similar images. The similar images may include the same specific information, or may be originated from the same image after an image process is performed. For example, a certain image cluster includes a certain person San Zhang, or a certain image cluster includes a certain specific information, such as tsunami, earthquake and so on. These similar images may be determined according to the conventional image recognition technique. In the image cluster, each image has the corresponding image description text, the description text of each image in the image cluster is extracted and saved in the text cluster, and each text cluster corresponding to each image cluster may be obtained.

S102, segmenting each image description text in the text cluster to obtain a base word of each image description text;

It is a conventional technology to segment each image description text, and is not illustrated again in the embodiment of the present disclosure. A skilled person in the art may determine the corresponding segmenting way according to the description of the embodiment of the present disclosure.

The base word included in each image description text is obtained after the image description text is segmented, each image description text may include one, two, three or more base words. The base words included in the image description text may be the same or different. For example, a certain image description text is segmented into base words A, B, C, A and D, then the base word included in the image description text is four, the base word A appears in the image description text twice.

S103, according to attribute information of the base word, determining a weight of each base word in each image description text, and determining a fractional value of each base word in each image description text.

When determining the weight of each base word in each image description text, it is capable to determine according to the attribute information of each base word. Specifically, aiming at each image description text, it is capable to determine the weight of the base word in the image description text according to the attribute information of each base word in the image description text and the time of the base word appearing in the image description text.

After determining the base word of each image description text, it is capable to determine the weight of the each base word in the image description text. Specifically, the weight of the base word in the image description text may be determined according to the attribute information of the base word and the time that the base word appearing in the image description text. The attribute information of the base word includes: the frequency information of the base word, the position information of the base word in the image description text, the number of bytes information included in the base word and the part-of-speech information of the base word and so on.

In addition, the image description text may include a plurality of same base words, the positon of each base word appearing in the image description text may be different. As a result, the same base word may correspond to a plurality of different sub-weights since the same base word may be located in different positions of the image description text in the same image description text. A plurality of sub-weights correspond to the same base word are added to obtain the weight of the base word in the image description text.

When the weight of each base word in each image description text is determined, aiming at each image description text, it is capable to determine the fractional value of each base word in the image description text according to the determined weight of each base word in the image description text and the sum of weight of each base word in the image description text of each image description text.

After the weight of each base word of the image description text in the image description text is determined, to ensure the importance degree of each base word in the image description text, in the embodiment of the present disclosure, it is needed to determine the fractional value of each base word in the image description text. When determining the fractional value of each base word in the image description text, according to the weight of each base word in the image description text, and the sum of weight of each base word in the image description text, determining the fractional value of the base word in the image description text.

By using the method above, in an image description text, the sum of the fractional value of each base word included in the image description text is 1.

S104, according to the fractional value of each base word in each image description text, determining a total fractional value of each base word in the text cluster.

Specifically, when determining the total fractional value of each base word in the text cluster, aiming at each base word in the text cluster, according to the fractional value of each base word in each image description text, determining the total fractional value of each base word in the text cluster.

When a base word appears in a high frequency in the text cluster, it shows the base word is very important to the text cluster. To measure the importance degree of the text cluster of each base word, in the embodiment of the present disclosure, aiming at each base word, it is capable to determine the total fractional value of each base word in the text cluster according to the determined sum of fractional value of each base word in each image description text, thusly taking the total fractional value as the importance degree for measuring the base word in the text cluster.

S105, according to the total fractional value of each base word in the text cluster, determining a core word of the image cluster.

When the total score value of each base word in the text cluster is determined, it is capable to determine the importance degree of each base word in the text cluster. According to the image description text of each base word in the text cluster, selecting a set number of base words as the core word of the image cluster according to the total score value of each base word in the text cluster.

In the embodiment of the present disclosure, aiming at the text cluster constituted of each image description text in the image cluster, according to the attribute information of each base word in each image description text, it is capable to determine the weight of each base word in each image description text, thusly determining the total fractional value of each base word in the text cluster, the core word of the image cluster is determined according to the total fractional value of each base word, thusly ensuring the selected core word to accurately describe the meaning of the image cluster.

In the embodiment of the present disclosure, in order to further accurately determine the core word of the image cluster, after determining the total fractional value of each base word in the text cluster, the method further includes: according to the total fractional value of each base word in the text cluster, determining the total score value of each image description text; according to the total score value of each image description text, deleting a set number of image description texts; determining whether the number of the image description texts included in the text cluster reaches a set convergence threshold, when the number of image description texts included in the text cluster reaches the set convergence threshold, it is capable to determine the core word of the image cluster in the text cluster, or, re-determining the total score value of each remained image description text in the text cluster until the core word of the image cluster is determined.

After the importance degree of each base word in the text cluster is determined, it is capable to determine the importance degree of each image description text in the text cluster according to the determined total fractional value of each base word in the text cluster. Specifically, it is capable to determine the total score value of each image description text according to the sum of the total fractional value of each base word in the text cluster included in the image description text.

After the total score value for measuring the importance degree of the image description text in the text cluster, it is capable delete the image description text with less total score value. At that moment, it is capable to consider the image description text is not important in the text cluster, thus the image description text may be deleted. When deleting the image description text, according to the set number each time, it is capable to delete the corresponding set number of image description texts. For example, if the set number is 1 or 2, every time when deleting the image description text, it is capable to delete the image description text with the lowest total score value, or deleting the image description text with two lowest scores.

After the set number of image description texts are deleted, and when the number of the remained image description texts in the text cluster reaches the set convergence threshold, it is capable to consider the remained image description texts in the text cluster are relatively important image description texts. When determining the core word in the image description text, the accuracy of the core word may be ensured.

After deleting the set number of image description texts, and when the remained image description text in the text cluster reaches a the set convergence threshold, to ensure the accuracy of the core word, in the embodiment of the present disclosure, since some image description texts are deleted, the total fractional value of the base word in the text cluster are changed, it is needed to re-determine the total score value of each image description text, thusly further deleting the set number of image description texts according to the total score value of each image description text, until the number of the image description texts of the text cluster reaches a set convergence threshold, therefore being facilitate in determining the core word.

In order to further improve the accuracy of extracting the core word of the image cluster and overcome some noise interference, in the embodiment of the present disclosure, before determining the weight of each base word in each image description text, it is capable to denoise each segmented base word, and to denoise each image description text. The two denoising ways above may be used together or separately. When used together, they may be performed simultaneously or in any sequence. Using two denoise ways at the same time may effectively avoid noise interference in the text cluster, and further improves the accuracy of extracting the core word.

In the embodiment of the present disclosure, denoising the segmented base word includes: matching each segmented base word with each word stored in a meaningless word library; when matched successfully, determining the base word is meaningless, and deleting the base word.

Specifically, in the embodiment, it is capable to pre-store the meaningless word library, the meaningless word library stores base words used as stop words such as “to”, “of”, “so” and other meaningless words relative to the core word. Since the meaningless word library stores some meaningless base words, each segmented base word is matched with each word in the meaningless word library, when the match is successful, it is considered the base word is meaningless word, and cannot be used as the core word, thus the base word is deleted. Otherwise, it is considered the base word may be the core word, and the base word is kept.

In order to effectively remove some interference image description text, in the embodiment of the present disclosure, it is capable to denoise the image description text in the text cluster. The specific process may include at least one step of: determining whether each image description text meets a set filter condition; when the image description text meets the filter condition, deleting the image description text; and, comparing each two image description texts, according to a sequence of the base word of the image description text, determining whether the number of the same base word appearing respectively in two image description texts reaches a set number threshold, when the number of the same base word appearing respectively in two image description texts reaches the set number threshold, deleting one of the two image description texts in the two image description text.

The reason why it is needed to perform denoising to the image description text in the text cluster is, some image description texts may be meaningless text, it provides very limited contribution to the core word, for example, the image description text is very short, the number of bytes it includes is less, or the image description text does not include noun to represent the text meaning, or, the image description text is very long, the number of bytes it includes is large, under these situations above, it is considered the image description text is meaningless.

As a result, it is capable to set filter conditions for the image description text according to the description above. In determining whether the image description text meets the set filter condition, it is capable to determine whether the number of bytes included in the image description text is less than a set first length threshold, when the number of bytes included in the image description text is less than the set first length threshold, it is considered the image description text meets the set filter condition, otherwise, it is capable to determine whether the image description text includes a noun, when the image description text does not include the noun, it is capable to consider the image description text meets the set filter condition, or it is capable to determine whether the number of bytes included in the image description text is larger than a set second length threshold, when the number of bytes included in the image description text is larger than a set second length threshold, it is considered the image description text meets the set filter condition, wherein the second length threshold is larger than the first length threshold. When the image description text meets the set filter condition, it is capable to delete the image description text.

In addition, in the embodiment of the present disclosure, when performing a copy and paste operation to a certain image description text, the text cluster may have a plurality of image description texts with the same content in the text cluster, the image description text obtained by copy and paste may affect the accuracy of determining the core word subsequently. Therefore, in order to overcome the copy and paste of the image description text from affecting the determination of the final core word, in the embodiment of the present disclosure, it is capable to determine whether one of each two image description texts is the image description text obtained by copy and paste from another image description text in each two image description texts.

Since the image description text obtained by copy and paste should be the same as the original image description text, when two image description texts are compared and determined, it is capable to first determine whether the numbers of base words included in the two image description texts are the same. When the numbers of the base words included in the base words included in the image description texts are different, it is capable to consider the two image description texts are not image description texts obtained by copy and paste. When the numbers of the base words included in the two image description texts are the same, according to the sequence of each base word in each image description text, comparing whether each base word in the two image description texts are the same. When the number of the base words appearing in the two image description texts in sequence reach a set number threshold, it is considered one of the image description texts is the image description texts obtained by copy and paste. One of the image description texts are deleted in the text cluster.

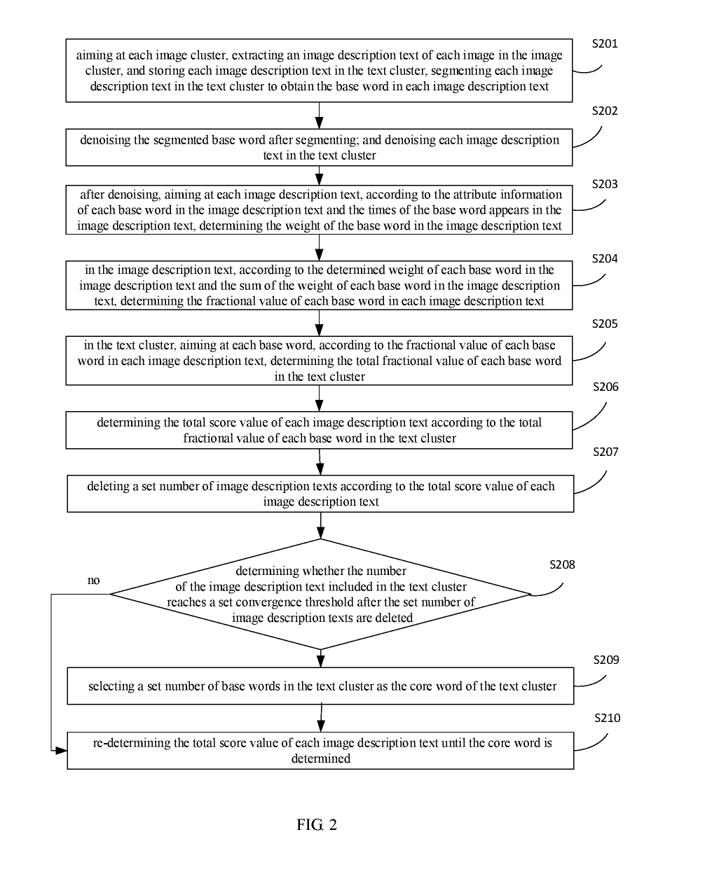

FIG. 2 is a schematic diagram showing the detailed implementing process of determining a core word of an image cluster description text according to an embodiment of the present disclosure; the process includes the steps of:

S201, aiming at each image cluster, extracting an image description text of each image in the image cluster, and storing each image description text in the text cluster, segmenting each image description text in the text cluster to obtain the base word of each image description text.

After segmenting the image description text, it is capable to record how many base words are included in each image description text, and which base words are they, and how many times each base word appears in the image description text, and what position they appear.

S202, denoising the segmented base word after segmenting; and denoising each image description text in the text cluster.

S203, after denoising, aiming at each image description text, according to the attribute information of each base word in the image description text and the times of the base word appearing in the image description text, determining the weight of the base word in the image description text.

S204, in the image description text, according to the determined weight of each base word in the image description text and the sum of the weight of each base word in the image description text, determining the fractional value of each base word in each image description text.

S205, in the text cluster, aiming at each base word, according to the fractional value of each base word in each image description text, determining the total fractional value of each base word in the text cluster.

S206, determining the total score value of each image description text according to the total fractional value of each base word in the text cluster.

S207, deleting a set number of image description texts according to the total score value of each image description text.

S208, determining whether the number of the image description text included in the text cluster reaches a set convergence threshold after the set number of image description texts are deleted. When the determining result is yes, performing step S209, otherwise performing step S210.

S209, selecting a set number of base words in the text cluster as the core word of the text cluster.

S210, re-determining the total score value of each image description text until the core word is determined.

In the embodiment of the present disclosure, after segmentation, the base word and the image description text obtained after segmentation are denoised, thusly may filter the interference in the text cluster, and further increase the accuracy of determining the core word subsequently.

To the base word and the image description text in the text cluster, after denoising, according to the attribute information of each base word, it is capable to determine the total score value of each image description text. Before determining the total score value of each image description text, firstly it is needed to determine the weight of each base word in the image description text. in the embodiment of the present disclosure, determining the weight of the base word in the image description text includes:

according to a calculated frequency of each base word, determining the base value of the base word; according to the position that the base word appears in the image description text and a position weight value which is set to correspond to each position, determining a position value of each base word; according to a number of bytes included in the base word and a length weight value which is set to correspond to the length of each kind of base word, determining a length value of the base word; according to a part-of-speech of the base word and a part-of-speech weight value which is set to correspond to each kind of part-of-speech, determining the part-of-speech value of the base word; according to the determined base value, determined position value, determined length value and determined part-of-speech value of the base word, determining a sub weight of the base word, according to the determined sum of the sub weights of the base word in each position of the image description text, determining the weight of the image description text in the base word.

When determining the weight of each base word in each image description text, aiming at each image description text, according to each base word included in the image description text, it is capable to determine the weight of each base word in the image description text. When determining, it is capable to determine according to the attribute information of the base word and the times that the base word appears in the image description text. The attribute information of the base word includes: the frequency of the base word (that is the inverse document frequency IDF), the position of the base word appears in the image description text (position), the number of bytes included in the base word (length), the part-of-speech of the base word (type) and other information.

It may be determined according to the following formula:

$$W = {\sum }_{j = 0}^{M} IDFj * Positionj * Lengthj * Typej$$

IDF is the base value of the base word, Position is the position value of the base word, the Length is the length value of the base word, the Type is the part-of-speech value of the base word, M is the times that the base word appears in the image description text, and W is the weight of the base word in the image description text.

The above formula is only one way of achieving the technical solution of the present disclosure, a skilled person in the art may have verification on the formula, but it is still in the scope of the present disclosure.

The different positions of the base word appearing in the image description text may identify the importance degree of the base word in the image description text, if the position of the base word in the image description text is relatively at the front, it means the image description text of the base word is important. On the contrary, if the positon is relatively at the back, the importance degree is relatively lower. Therefore, it is capable to set the position weight value of each positon, according to the position of each base word in the image description text, and the set weight value corresponding to each position, determining the position value of each base word.

The number of bytes included in the base word may reflect the importance degree of the base word. When the number of bytes included in the base word is large, it may represent that the base word includes more information, and the base word is relatively more important. On the contrary, if the number of bytes included in the base word is small, it may represent that the base word includes less information, and the base word is relatively less important. Therefore, it is capable to set a length weight value corresponding to the length of the base word, according to the number of bytes of each base word and the set length weight value corresponding to the length of the base word, it is capable to determine the length value of the base word.

When the part-of-speech of the base word is different, the importance degree of the base word is different. Generally, noun may represents important meaning, adjectives represents the meaning weaker than noun, but stronger than verbs, as a result, it is capable to set the part-of-speech weight value corresponding to each kind of part-of-speech according to the importance degree of the part-of-speech. After the part-of-speech of the base word is determined, according to the part-of-speech weight value corresponding to each kind of part-of-speech, it is capable to determine the part-of-speech of the base word. Determining the part-of-speech of the base word is the conventional technology, it is not illustrated in the embodiment of the present disclosure for concise.

After the base value, the position value, the length value and the part-of-speech value of the base word are determined, the base word, the position value, the length value and the part-of-speech value are added to be the sub-weight of the base word. If the base word in the image description text appears only once, it means the sub-weight of the base word is the weight of the image description text, if the base word appears in the image description text for many times, it means the sum of the sub-weights corresponding to the base word appearing in each position of the image description text is the weight of the base word in the image description text.

Aiming at each image description text, according to each base word included in the image description text, after determining the weight of each base word in the image description text, according to the weight of each base word in the image description text, and the sum of weight of each base word in the image description text of the image description text, it is capable to determine the fractional value of each base word in the image description text, that is determining the voting score of each base word in the image description text.

The specific calculation may be as below:

$$Fk = ( \frac{Wk}{{\sum }_{k = 0}^{N} Wk} ) * Wtext$$

Fk is a voting score of the kth base word in the image description text, that is the fractional value of the k^{th} base word in the image description text, the Wk is the weight of the k^{th} base word in the image description text of the image description text, the image description text includes N base words, Wtext is the base voting score of the image description text, in order to simplify, the Wtext corresponding to each image description text is 1.

The above formula is only one way of achieving the technical solution of the present disclosure, a skilled person in the art may have verification on the formula, but it is still in the scope of the present disclosure.

After the above process, the sum of the fractional values of each base word in the image description text is 1, the fractional value of the base word in the image description text may reflect the importance degree of the base word in the image description text, and may also reflect the voting result of the base word.

After the fractional value of each base word in each image description text is determined, aiming at the same base word, according to the sum of the fractional value of the base word in different image description texts, it is capable to determine the total fractional value of the base word in the text cluster, thus obtaining the total fractional value of each base word in the text cluster, the total fractional value may reflect the voting result to the base word in the text cluster, the specific calculation may be as below:

$${Wi}^{′} = {\sum }_{i = 0}^{N} Wi$$

Wi is the fractional value of the base word in the i^{th} image text, N is the number of the image description texts included in the text cluster, when the image description text does not have the base word, the fractional value of the base word in the image description text is 0, Wi′ is the total fractional value of the base word in the text cluster.

The above formula is only one way of achieving the technical solution of the present disclosure, a skilled person in the art may have verification on the formula, but it is still in the scope of the present disclosure.

According to the determined total fractional value of each base word in the text cluster, and according to the base word included in each image description text, it is capable to take the sum of the total fractional value of each base word in the text cluster as the total score value of the image description text, the specific calculation may be as below:

$$Tw = {\sum }_{i = 0}^{K} {Wi}^{′}$$

Tw is the total score value of the image description text, Wi′ is the total fractional value of the base word in the image description text in the text cluster, k is the number of the base words included in the image description text.

The above formula is only one way of achieving the technical solution of the present disclosure, a skilled person in the art may have verification on the formula, but it is still in the scope of the present disclosure.

After the total score value of each image description text is obtained, the voting result to the image description text is determined. The set number of image description texts are deleted according to the total score value of the image description text, deleting the set number of image description texts having lower total score value, the set number may be one or more, the user may set different quantities according to requirement. After the set number of image description texts are deleted from the text cluster, determining whether the text cluster satisfies a condition of convergence, that is, determining whether the number of the image description texts included in the text cluster reaches a set convergence threshold after the set number of image description texts are deleted. For example, it is determined whether the number of the image description texts included in the text cluster is less than 4.

When the number of the image description texts included in the text cluster reaches a set convergence threshold, it is capable to determine the remaining image description text in the text cluster is the relatively more important image description text obtained by voting. Then it is capable to select the set number of base words in the image description text as the core word of the text cluster. The set number may be 3, 4 or 5, it may be set according to requirement. When selecting the core word, it is capable to select the base word having higher total fractional value in the text cluster or select at according to the user's will.

When the number of the image description texts included in the text cluster does not reach the set convergence threshold, some of the image description texts in the text cluster are deleted, therefore, the total fractional value of some base words in the text cluster may change. Therefore, in order to determine the core word of the text cluster, in the embodiment of the present disclosure, it is needed to re-determine the total score value of the remaining image description text in the text cluster.

It is capable to use the method above to re-determine the total score value of each remained image description text in the text cluster, that is, it is capable to use the fractional value of each base word in each image description text to determine the total fractional value of each base word in the text cluster after the image description texts in the text cluster are deleted. The total score value of each image description text is determined according to the total fractional value of each base word in the text cluster.

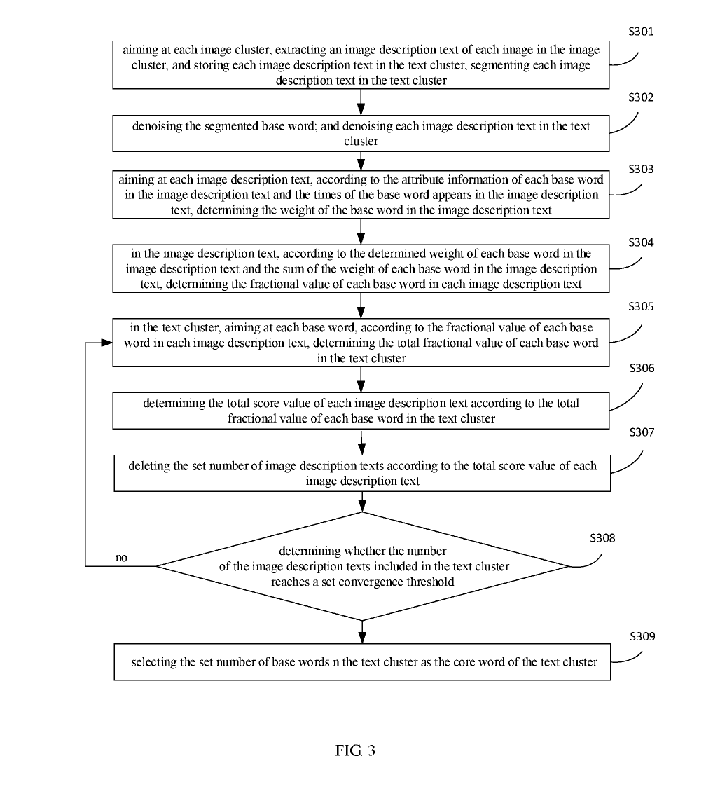

FIG. 3 is another schematic diagram showing the detailed implementing process of determining a core word of an image cluster description text according to an embodiment of the present disclosure; the process includes the following steps of:

S301, aiming at each image cluster, extracting an image description text of each image in the image cluster, and storing each image description text in the text cluster, segmenting each image description text in the text cluster.

S302, denoising the segmented base word; and denoising each image description text in the text cluster.

S303, after denoising, aiming at each image description text, according to the attribute information of each base word in the image description text and the times of the base word appears in the image description text, determining the weight of the base word in the image description text.

S304, in the image description text, according to the determined weight of each base word in the image description text and the sum of the weight of each base word in the image description text, determining the fractional value of each base word in each image description text.

S305, in the text cluster, aiming at each base word, according to the fractional value of each base word in each image description text, determining the total fractional value of each base word in the text cluster.

S306, determining the total score value of each image description text according to the total fractional value of each base word in the text cluster.

S307, deleting the set number of image description texts according to the total score value of each image description text.

S308, determining whether the number of the image description texts included in the text cluster reaches a set convergence threshold after the set number of image description texts are deleted. When the determining result is yes, performing step S309, otherwise performing step S305.

S309, selecting the set number of base words in the text cluster as the core word of the text cluster.

In the embodiment of the present disclosure, according to the voting result, adjusting the voting behavior, thusly makes the voting result more accurate, in order to determine a relatively more accurate core word, in the embodiment of the present disclosure, when re-determining the total score value of the image description text, further includes: according to the fractional value of each base word in each image description text, performing uniformization on the fractional value of the base word after deleting the image description text from the text cluster, and determining the uniformized fractional value of the base word in each image description text; aiming at each image description text, according to the uniformized fractional value of each base word, determining the uniformized total score value of each image description text.

Specifically, the performing uniformization to the fractional value of the base word comprises: according to the fractional value of each base word in each image description text, determining the total fractional value of the base word in the text cluster; according to the sum of the determined total fractional value of the base word and the fractional value of the base word in each image description text, performing a uniformization on the fractional value of the base word; or, according to the product of the determined total fractional value of the base word and the fractional value of the base word in each image description text, performing a uniformization to the fractional value of the base word.

Specifically, in processing, according to the remained image description text in the text cluster, according to the fractional value of each base word in each image description text, performing a uniformization on the fractional value of the base word in the text cluster, thereby determining the uniformized fractional value of each base word in the text cluster.

For example, aiming at base word A, the base word appears in four image description texts of the text cluster, fractional values of the base word A in each image description text is 0.5, 0.5, 0.3 and 0.5 respectively, when determining the uniformized fractional value of the base word A in each image description text, the fractional values of the base word A in each image description text are added (0.5+0.5+0.3+0.5=1.8), 1.8 times 0.5 obtains the first product, 1.8 times (0.5+0.5+0.3+0.5) obtains the second product, the quotient of the first product and the second product is taken as the uniformized fractional value of the base word A in the image description text, according to the fractional value of the base word A in each image description text, the uniformized fractional value of the base word A in each image description text is determined. Wherein the uniformized fractional value of the base word A in the first, second and fourth image description texts are equal, they are respectively the first product of 1.8 and 0.5, the second product of 1.8 and (0.5+0.5+0.3+0.5), the quotient of the first product and the second product, the uniformized fractional value of the base word in the third image description text is the quotient of the first product and the second product, wherein 1.8 times 0.3 obtains the first product, 1.8 times (0.5+0.5+0.3+0.5) obtains the second product.

Specific calculation formula may be as follows:

$${Fi}^{″} = ( {Fi}^{′} * Fi ) / ( {\sum }_{i = 0}^{K} {Fi}^{′} * Fi )$$

Fi″ is the uniformized fractional value of the base word in the i^{th} image description text, Fi′ is the total fractional value of the base word in the text cluster, Fi is the fractional value of the base word in the i^{th} image description text, K is the number of the image description texts included in the text cluster.

The above formula is only one way of achieving the technical solution of the present disclosure, a skilled person in the art may have verification on the formula, but it is still in the scope of the present disclosure.

Or, in the embodiment of the present disclosure, in order to ensure the accuracy of the determined core word, when performing uniformization on the fractional value of the base word, it is also capable to use the sum way to determine. Follow the above example, aiming at base word A, the base word appears in four image description texts in the text cluster, the fractional values of the base word A in each image description text is 0.5, 0.5, 0.3 and 0.5, in determining the uniformized fractional value of the base word A in each image description text, it is capable to add the fractional values of the base word A in each image description text, 0.5+0.5+0.3+0.5=1.8, 1.8 adding 0.5 obtains the first sum, and 1.8 adding (0.5+0.5+0.3+0.5) obtains the second sum, the quotient of the first sum and the second sum is taken as the uniformized fractional value of the base word A in the image description text, according to the fractional value of the base word A in each image description text, the uniformized fractional value of the base word A in each image description text is determined. Wherein the uniformized fractional value of the base word A in the first, second and fourth image description texts are equal, they are respectively the first sum of 1.8 adding 0.5, the second sum is 1.8 adding (0.5+0.5+0.3+0.5), the quotient of the first sum and the second sum, the uniformized fractional value of the base word in the third image description text is the quotient of the first sum and the second sum, wherein 1.8 adding 0.3 obtains the first sum, 1.8 adding (0.5+0.5+0.3+0.5) obtaining the second sum.

No matter which way is used, after determining the uniformized fractional value of each base word in each image description text, according to the uniformized fractional value of the base word included in each image description text, it is capable to determine the uniformized total score value of each image description text, deleting the set number of image description texts which have lower total score value, determining whether the number of the image description texts included in the text cluster reaches a set convergence threshold after the set number of image description texts are deleted. When the number of the image description texts included in the text cluster reaches a set convergence threshold, selecting the set number of base words in the text cluster as the core word of the importance degree corresponding to the text cluster, or, repeat the above process until the core word is determined.

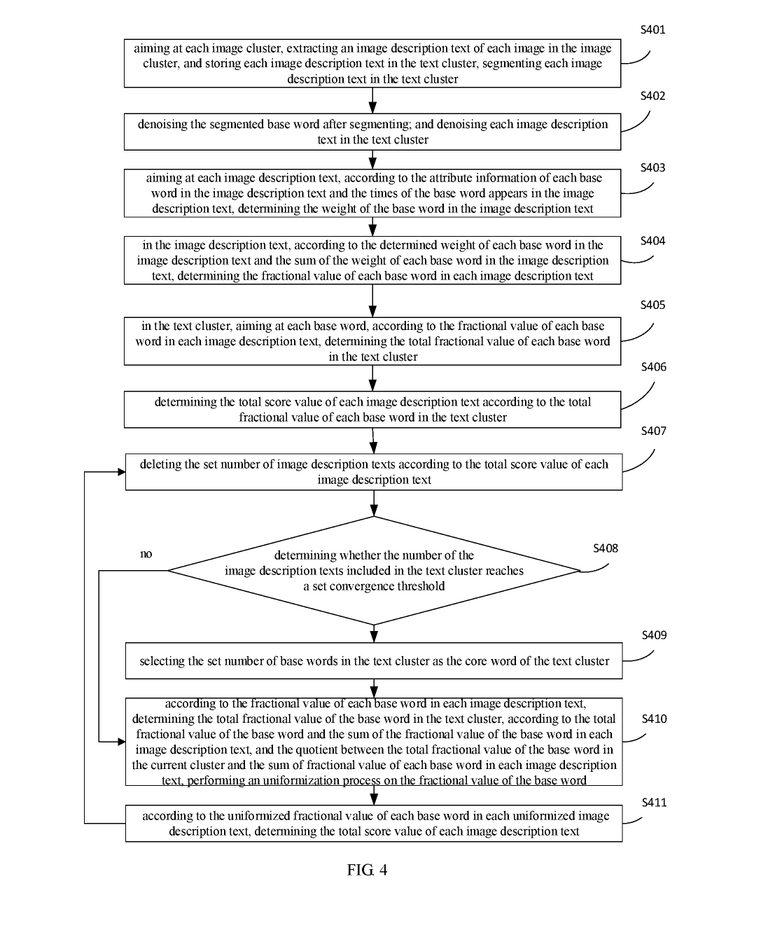

FIG. 4 is still another schematic diagram showing the detailed implementing process of determining a core word of an image cluster description text according to an embodiment of the present disclosure; the process includes the following steps:

S401, aiming at each image cluster, extracting an image description text of each image in the image cluster, and storing each image description text in the text cluster, segmenting each image description text in the text cluster.

S402, denoising the segmented base word; and denoising each image description text in the text cluster.

S403, after denoising, aiming at each image description text, according to the attribute information of each base word in the image description text and the times of the base word appears in the image description text, determining the weight of the base word in the image description text.

S404, in the image description text, according to the determined weight of each base word in the image description text and the sum of the weight of each base word in the image description text, determining the fractional value of each base word in each image description text.

S405, in the text cluster, aiming at each base word, according to the fractional value of each base word in each image description text, determining the total fractional value of each base word in the text cluster.

S406, determining the total score value of each image description text according to the total fractional value of each base word in the text cluster.

S407, deleting the set number of image description texts according to the total score value of each image description text.

S408, determining whether the number of the image description texts included in the text cluster reaches a set convergence threshold after the set number of image description texts are deleted. When the determining result is yes, performing step S409, otherwise performing step S410.

S409, selecting the set number of base words in the text cluster as the core word of the text cluster.

S410, according to the fractional value of each base word in each image description text, determining the total fractional value of the base word in the text cluster, according to the total fractional value of the base word and the sum of the fractional value of the base word in each image description text, and the quotient between the total fractional value of the base word in the current cluster and the sum of fractional value of each base word in each image description text, performing an uniformization process on the fractional value of the base word.

S411, according to the uniformized fractional value of each base word in each uniformized image description text, determining the total score value of each image description text, then performing step S407.

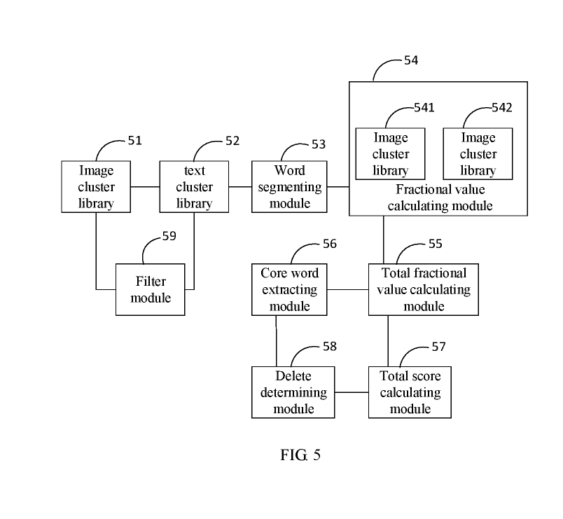

FIG. 5 is a schematic diagram showing the structure of the apparatus for determining a core word of an image cluster description text according to an embodiment of the present disclosure; the apparatus includes: an image cluster library 51, configured to store each image description text in the text cluster, wherein each image cluster comprises a plurality of images, and determining the core word of each image cluster according to a core word extracting module, storing the relation between each image cluster and the core word; a text cluster library 52 configured to aiming at each image cluster, storing a text cluster constituted by the image description text extracted from each image; word segmenting module 53, configured to segment each image description text in the text cluster to obtain a base word in each image description text; a fractional value calculation module 54, configured to determine the weight of each base word in each image description text according to the attribute information of each base word, and determine the fractional value of each base word in each image description text; a total fractional value calculation module 55, configured to determine the total fractional value of each base word in the text cluster according to the fractional value of each base word in each image description text, a core word extracting module 56, configured to determine the core word of the image cluster according to the determined total fractional value of each base word in the text cluster.

The fractional value calculation module 54 includes: a weight calculating unit 541, according to each image description text, according to the attribute information of each base word of the segmented image description text and the time that the base word appearing in the image description text, determining the weight of the base word in the image description text; a fractional value calculating unit 542, configured to determine the fractional value of each base word in the image description text according to the weight of each base word in the image description text and the sum of weight of each base word in the image description text, aiming at each image description text.

Preferably, in the embodiment of the present disclosure, in order to accurately determine the core word of the importance degree, the weight calculating module 541 is specifically configured to determine the base value of the base word according to the frequency of each base word, according to the appearing position of the base word in the image description text, according to the position that the base word appears in the image description text and the set position weight value corresponding to each position, determining the position value of each base word; according to number of bytes of the base word and the set length weight value of each kind of base word length, determining the length of the base word; according to the part-of-speech of the base word and the set part-of-speech weight value corresponding to each part-of-speech, determining the part-of-speech value of the base word; according to the base value, position value, length value and part-of-speech value of the base word, determining the sub weight of the base word; according to the determined sum of the sub weight in each position of the image description text, determining the weight of the image description text in the base word.

The apparatus further includes: a total score value calculating module 57, configured to determine the total score value of each image description text according to the determined total fractional value of each base word in the text cluster; a deleting determining module 58, configured to delete a set number of image description texts of the image description text according to the total score value of each image description text; determining whether the number of the image description text in the text cluster reaches a set convergence threshold after the set number of image description texts are deleted; when it is determined the number of image description texts included in the text cluster does not reach the set convergence threshold, informing the total score value calculating module to re-determine the total score value of each remained image description text in the text cluster; the core word extracting module 56, further configured to determine the core word of the image cluster in the text cluster when the deleting determining module determines that the number of the image description text included in the text cluster reaches a set convergence threshold.

Preferably, in the embodiment of the present disclosure, in order to select accurate core word according to the fractional value of each base word in each image description text and affecting other fractional values of other base words, the total score value calculating module 57 is further configured to determine the total fractional value of each base word in the text cluster according to the fractional value in each remained image description text of the text cluster of each base word; determine the total score value of each image description text according to the total fractional value of each base word in the text cluster.

Preferably, in the embodiment of the present disclosure, in order to select accurate core word according to the fractional value of each base word in each image description text and affecting other fractional values of other base words, the total score value calculating module 57 is further configured to perform uniformization on the fractional value of the base word according to the fractional value of each base word in each remained image description text in the text cluster; determining a uniformized fractional value of the base word in each image description text; aiming at each image description text, according to the uniformized fractional value of each base word, determine the total score value of each image description text.

Preferably, in the embodiment of the present disclosure, in order to select accurate core word according to the fractional value of each base word in each image description text and affecting other fractional values of other base words, the total score value calculating module 57 is specifically configured to determine the total fractional value of the base word in the text cluster according to the fractional value of each base word in each image description text, according to the determined total fractional value of the base word and the sum of the fractional value of the base word in each image description text, performing a uniformization on the fractional value of the base word.

Preferably, in the embodiment of the present disclosure, in order to select accurate core word according to the fractional value of each base word in each image description text and affecting other fractional values of other base words, the total score value calculating module 57 is specifically configured to determine the total fractional value of the base word in the text cluster according to the fractional value of each base word in each image description text, according to the determined total fractional value of the base word and the product of the fractional value of the base word in each image description text, performing a uniformization on the fractional value of the base word.

Preferably, in the embodiment of the present disclosure, in order to more specifically determine the core word of the image description text, the apparatus further includes: a filter module 59, configured to denoise the segmented base word; and/or denoise each image description text in the text cluster.

Preferably, in the embodiment of the present disclosure, in order to more specifically determine the core word of the image description text, the filter module 59 is specifically configured to match each segmented base word with each word stored in a meaningless word library, when matched successfully, it is determined the base word is meaningless, the base word is deleted.

Preferably, in the embodiment of the present disclosure, in order to more specifically determine the core word of the image description text, the filter module 59 is specifically configured to determine whether each image description text meets a set filter condition; when the image description text satisfies the filter condition, deleting the image description text; and/or compare each two image description texts, according to a sequence of the base word of the image description text, determine whether the number of the same base words appearing in two image description texts reaches a set number threshold, when the number of the same base word appearing in two image description texts reaches the set number threshold, delete one of the two image description texts in the two image description text.

The disclosure discloses a method and an apparatus for determining a core word of an image cluster description text, The method aiming at a text cluster comprising each image description text in an image cluster, segmenting the each image description text in the text cluster, and based on attribute information of each base word, determining a fractional value of the each base word in the each image description text and a total fractional value of the each base word in the text cluster, and thus determining a core word of the image cluster. Embodiments of the present application aim at a text cluster comprising each image description text in an image cluster, based on attribute information of a base word in the each image description text, determine a weight of each base word in the each image description text, determine a total fractional value of the each base word in the text cluster, based on the total fractional value of the each base word, determine a core word of the image cluster, and thus can ensure that the selected core word can accurately describe a meaning of the image cluster.

Although the preferred embodiment of the present disclosure of the present disclosure is described above, a skilled person in the art may change and modify the embodiments once he or she knows the concept of the disclosure. As a result, the appended claims are intended to include all the preferable embodiments and the changes and modifications within the scope of the present disclosure.

Obviously, a skilled person in the art may change or modify the present disclosure without escaping the sprit and scope of the present disclosure. If the changes and modifications of the present disclosure belongs to the same scope of the claims and the equally technical solutions, the present disclosure is intended to include the changes and modifications. Each of apparatus according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the apparatus equipment of determining the image cluster description text core word according to the embodiments of the disclosure. The disclosure may further be implemented as apparatus program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

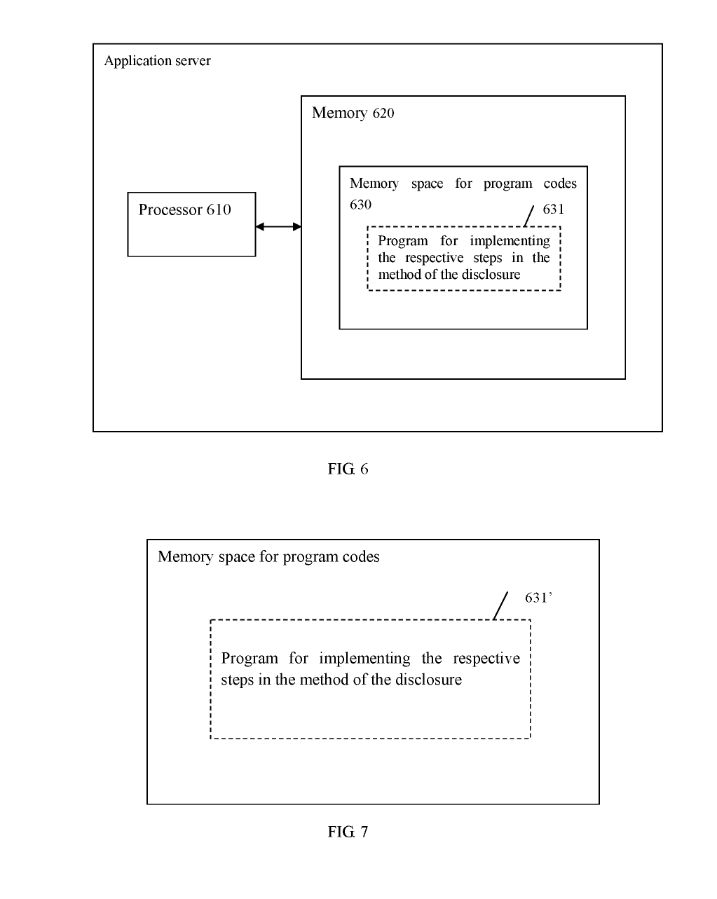

For example, FIG. 6 illustrates a block diagram of a computing apparatus for implementing the method for determining the image cluster description text core word according the disclosure. Traditionally, the computing apparatus includes a processor 610 and a computer program product or a computer readable medium in form of a memory 620. The memory 620 could be electronic memories such as flash memory, EEPROM (Electrically Erasable Programmable Read—Only Memory), EPROM, hard disk or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 7. The memory cells may be provided with memory sections, memory spaces, etc., similar to the memory 620 of the server as shown in FIG. 6. The program codes may be compressed for example in an appropriate form. Usually, the memory cell includes computer readable codes 631′ which can be read for example by processors 610. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of apparatus, some of these apparatus may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

1. A method for determining a core word of an image cluster description text, comprising:
aiming at each image cluster, extracting an image description text of each image in the image cluster, and storing each image description text in a text cluster;
segmenting each image description text in the text cluster to obtain a base word of each image description text;
according to attribute information of the base word, determining a weight of each base word in each image description text, and determining a fractional value of each base word in each image description text;
according to the fractional value of each base word in each image description text, determining a total fractional value of each base word in the text cluster;
according to the total fractional value of each base word in the text cluster, determining the core word of the image cluster.

2. The method according to claim 1, wherein the determining the weight of each base word in each image description text comprises:
aiming at each image description text, according to the attribute information of each base word in the segmented image description text and the times that the base word appears in the image description text, determining the weight of the base word in the image description text.

3. The method according to claim 1, wherein the determining the weight of the base word in the image description text comprises:
according to a calculated frequency of each base word, determining a base value of the base word;
according to the position that the base word appears in the image description text and a position weight value which is set to correspond to each position, determining a position value of each base word;
according to a number of bytes included in the base word and a length weight value which is set to correspond to the length of each kind of base word, determining a length value of the base word;
according to a part-of-speech of the base word and a part-of-speech weight value which is set to correspond to each kind of part-of-speech, determining the part-of-speech value of the base word;
according to the determined base value, the determined position value, the determined length value and the determined part-of-speech value of the base word, determining a sub weight of the base word;
according to the determined sum of the sub weights of the base word in each position of the image description text, determining the weight of the image description text in the base word.

4. The method according to claim 1, wherein the determining the fractional value in each base word of each image description text comprises:
aiming at each image description text, according to the determined weight of each base word in the image description text and the sum of weight of each base word of the image description text in the image description text, determining the fractional value of each base word in each image description text.

5. The method according to claim 4, wherein the determining the total fractional value of each base word in the text cluster comprises:
in the text cluster, aiming at each base word, according to the fractional value of each base word in the image description text, determining the total fractional value of each base word in the text cluster.

6. The method according to claim 1, wherein after determining the total fractional value of each base word in the text cluster, the method further comprises:
according to the total fractional value of each base word in the text cluster, determining the total score value of each image description text;
according to the total score value of each image description text, detecting to set number of image description texts;
determining the number of image description texts included in the text cluster reaches a set convergence threshold after the a set number of image description texts are deleted;
when the number of the image description text included in the text cluster reaches a set convergence threshold, determining the core word of the image cluster in the text cluster, otherwise, re-determining the total score value of each remained image description text in the text cluster until the core word of the image cluster is determined.

7. The method according to claim 6, wherein the re-determining total score value of each remained image description text in the text cluster comprises:
according to the fractional value of each base word in each remained image description text of the text cluster, determining the total fractional value of each base word in the text cluster;
according to the total fractional value of each base word in the text cluster, determining the total score value of each image description text; or according to the fractional value of each base word in each remained image description text of the text cluster, performing uniformization on the fractional value of the base word, and determining the uniformized fractional value of the base word in each image description text; aiming at each image description text, according to the uniformized fractional value of each base word, determining the uniformized total score value of each image description text.

8. The method according to claim 7, wherein the performing uniformization on the fractional value of the base word comprises:
according to the fractional value of each base word in each image description text, determining the total fractional value of the base word in the text cluster; according to the sum of the determined total fractional value of the base word and the fractional value of the base word in each image description text, performing uniformization on the fractional value of the base word; or
according to the fractional value of each base word in each image description text, determining the total fractional value of the base word in the text cluster; according to the product of the determined total fractional value of the base word and the fractional value of the base word in each image description text, performing uniformization on the fractional value of the base word.

9. The method according to claim 1, wherein before determining the weight of each base word in each image description text, the method further comprises at least one of the steps of:
denoising the segmented base word; and
denoising each image description text in the text cluster.

10. The method according to claim 9, wherein the denoising the segmented base word comprises:
matching each segmented base word with each word stored in a meaningless word library;
when matched successfully, determining the base word is a meaningless word, deleting the base word.

11. The method according to claim 9, wherein the denoising each image description text in the text cluster comprises at least one processing step of:
determining whether each image description text meets a set filter condition; when the image description text meets the filter condition, deleting the image description text; and
comparing each two image description texts, according to a sequence of the base words in the image description texts, determining whether the number of the same base words appearing in the two image description texts reaches a set number threshold, when the number of the same base words appearing in the two image description texts reaches the set number threshold, deleting one of the two image description texts.

12. An apparatus for determining a core word of an image cluster description text, comprising:
a memory having instructions stored thereon;
a processor configured to execute the instructions to perform operations for determining a core word of an image cluster description text, comprising:
storing each image cluster, wherein each image cluster comprises a plurality of images, and determining the core word of each image cluster according to a core word extracting module, storing a relation between each image cluster and the core word;
storing a text cluster constituted by the image description texts extracted from each image in the image cluster aiming at each image cluster;
segmenting each image description text in the text cluster and obtaining a base word in each image description text;
determining a weight of each base word in each image description text according to attribute information of each base word, and determining the fractional value of each base word in each image description text;
determining the total fractional value of each base word in the text cluster according to the fractional value of each base word in each image description text;
determining the core word of the image cluster according to the determined total fractional value of each base word in the text cluster.

13. (canceled)

14. A computer readable medium, having computer programs stored thereon that, when executed by one or more processors of a computing device, cause the computing device to perform:
aiming at each image cluster, extracting an image description text of each image in the image cluster, and storing each image description text in a text cluster,
segmenting each image description text in the text cluster to obtain a base word of each image description text,
according to attribute information of the base word, determining a weight of each base word in each image description text, and determining a fractional value of each base word in each image description text,
according to the fractional value of each base word in each image description text, determining a total fractional value of each base word in the text cluster;
according to the total fractional value of each base word in the text cluster, determining the core word of the image cluster.

15. The apparatus according to claim 12, wherein the determining the weight of each base word in each image description text comprises:
aiming at each image description text, according to the attribute information of each base word in the segmented image description text and the times that the base word appears in the image description text, determining the weight of the base word in the image description text.

16. The apparatus according to claim 12, wherein the determining the weight of the base word in the image description text comprises:
according to a calculated frequency of each base word, determining a base value of the base word;
according to the position that the base word appears in the image description text and a position weight value which is set to correspond to each position, determining a position value of each base word;
according to a number of bytes included in the base word and a length weight value which is set to correspond to the length of each kind of base word, determining a length value of the base word;
according to a part-of-speech of the base word and a part-of-speech weight value which is set to correspond to each kind of part-of-speech, determining the part-of-speech value of the base word;
according to the determined base value, the determined position value, the determined length value and the determined part-of-speech value of the base word, determining a sub weight of the base word;
according to the determined sum of the sub weights of the base word in each position of the image description text, determining the weight of the image description text in the base word.

17. The apparatus according to claim 12, wherein the determining the fractional value in each base word of each image description text comprises:
aiming at each image description text, according to the determined weight of each base word in the image description text and the sum of weight of each base word of the image description text in the image description text, determining the fractional value of each base word in each image description text.

18. The apparatus according to claim 12, wherein the processor is further configured to perform:
according to the total fractional value of each base word in the text cluster, determining the total score value of each image description text;
according to the total score value of each image description text, detecting to set number of image description texts;
determining the number of image description texts included in the text cluster reaches a set convergence threshold after the a set number of image description texts are deleted;
when the number of the image description text included in the text cluster reaches a set convergence threshold, determining the core word of the image cluster in the text cluster, otherwise, re-determining the total score value of each remained image description text in the text cluster until the core word of the image cluster is determined.

19. The apparatus according to claim 18, wherein the re-determining total score value of each remained image description text in the text cluster comprises:
according to the fractional value of each base word in each remained image description text of the text cluster, determining the total fractional value of each base word in the text cluster; according to the total fractional value of each base word in the text cluster, determining the total score value of each image description text; or
according to the fractional value of each base word in each remained image description text of the text cluster, performing uniformization on the fractional value of the base word, and determining the uniformized fractional value of the base word in each image description text; aiming at each image description text, according to the uniformized fractional value of each base word, determining the uniformized total score value of each image description text.

20. The apparatus according to claim 19, wherein the performing uniformization on the fractional value of the base word comprises:
according to the fractional value of each base word in each image description text, determining the total fractional value of the base word in the text cluster; according to the sum of the determined total fractional value of the base word and the fractional value of the base word in each image description text, performing uniformization on the fractional value of the base word; or
according to the fractional value of each base word in each image description text, determining the total fractional value of the base word in the text cluster; according to the product of the determined total fractional value of the base word and the fractional value of the base word in each image description text, performing uniformization on the fractional value of the base word.

21. The apparatus according to claim 12, wherein the processor is further configured to perform:
denoising the segmented base word; and
denoising each image description text in the text cluster.
